(19) United States
(12) Patent Application Publication
(10) Pub. No.: US 2026/0085570 A1
(43) Pub. Date: Mar. 26, 2026

(54) VEHICLE DOOR CONTROL DEVICE

(71) Applicant: AISIN CORPORATION, Kariya (JP)

(72) Inventor: Takuya TAMURA, Kariya-shi (JP)

(73) Assignee: AISIN CORPORATION, Kariya (JP)

(21) Appl. No.: 19/316,303

(22) Filed: Sep. 2, 2025

(30) Foreign Application Priority Data
Mar. 31, 2025 (JP) 2025-057867
Sep. 24, 2024 (JP) 2024-165096

(51) Int. Cl. E05F 15/76; E05F 15/73

(52) U.S. Cl. CPC E05F 15/76; E05F 2015/767; E05Y 2900/531

(57) ABSTRACT

A vehicle door control device includes: a usage intention value calculation unit configured to calculate, for each of a plurality of conditions in which targets of calculation sources are different, a usage intention value indicating a possibility that a user present around a vehicle uses the vehicle; a target door estimation unit configured to estimate a target door, which is a door expected to be opened by the user among doors of the vehicle, based on the usage intention value calculated by the usage intention value calculation unit; and a control unit configured to execute control for opening the door on the target door estimated by the target door estimation unit.

### CROSS REFERENCE TO RELATED APPLICATIONS

This application is based on and claims priority under 35 U.S.C. §119 to Japanese Patent Applications 2024-165096, filed on September 24, 2024, and 2025-057867, filed on March 31, 2025, the entire content of which is incorporated herein by reference.

### TECHNICAL FIELD

This disclosure relates to a vehicle door control device that controls a door of a vehicle.

### BACKGROUND DISCUSSION

JP2022-134315A (Reference 1) describes a vehicle in which a motion of a user present behind the vehicle is determined and a back door of the vehicle is unlocked based on a determination result. A control device of the vehicle in Reference 1 captures an image of a user behind the vehicle by a camera mounted on the vehicle, and detects a motion of the user relative to a predetermined horizontal plane based on the captured image of the camera. When the control device detects a motion of moving a right leg in a right direction and then returning the right leg moved in the right direction to an original position from a state where both legs and both knees of the user are stationary, the control device unlocks the back door of the vehicle.

The control device in Reference 1 requests the user to perform the predetermined motion to unlock the back door of the vehicle. Therefore, the user needs to accurately perform the predetermined motion to unlock the door. There are various types of vehicle doors such as a swing door and a slide door, and a position of the user before opening the door and an orientation of the user with respect to the vehicle vary depending on the type of the door and an opening direction of the door. Therefore, if it is determined whether to open the door of the vehicle only under a specific condition, usability may decrease.

A need thus exists for a vehicle door control device which is not susceptible to the drawback mentioned above.

### SUMMARY

A vehicle door control device according to an aspect of this disclosure includes: a usage intention value calculation unit configured to calculate, for each of a plurality of conditions in which targets of calculation sources are different, a usage intention value indicating a possibility that a user present around a vehicle uses the vehicle; a target door estimation unit configured to estimate a target door, which is a door expected to be opened by the user among doors of the vehicle, based on the usage intention value calculated by the usage intention value calculation unit; and a control unit configured to execute control for opening the door on the target door estimated by the target door estimation unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view showing a vehicle according to a first embodiment;

FIG. 2 is a block diagram showing a configuration of a vehicle door control device according to the first embodiment;

FIG. 3 is a flowchart showing a door control processing program according to the first embodiment;

FIG. 4 is a diagram showing a flow from calculation of a usage intention value to determination by a threshold according to the first embodiment;

FIG. 5 is a diagram showing an example of a moving path of a user and a state in which the vehicle is parked according to the first embodiment;

FIG. 6 is a flowchart showing a door control processing program according to a second embodiment;

FIG. 7 is a flowchart showing the door control processing program according to the second embodiment; and

FIG. 8 is a diagram showing an example of a moving path of a user and a state in which a vehicle is parked according to the second embodiment.

### DETAILED DESCRIPTION

### First Embodiment

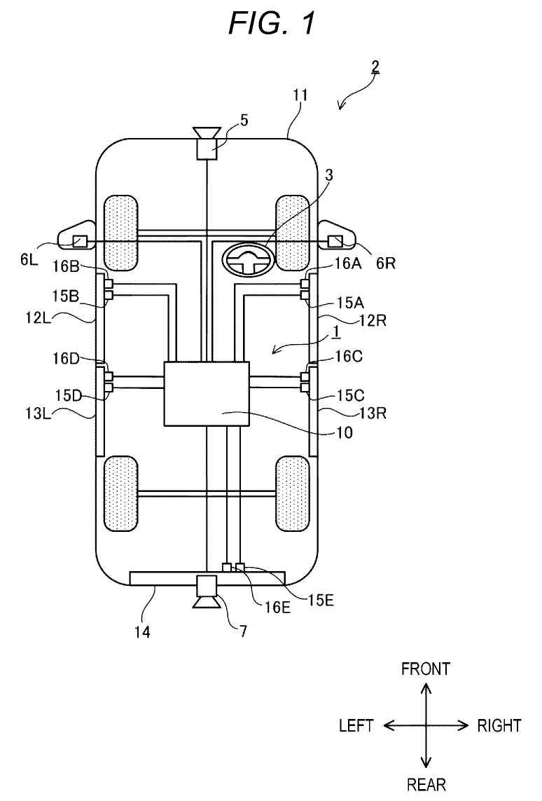

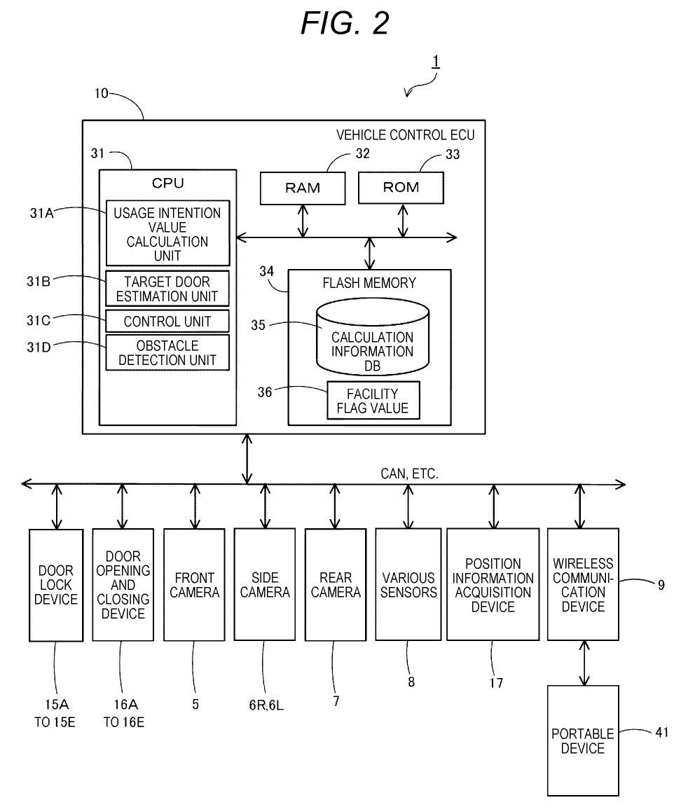

Hereinafter, a vehicle door control device according to a first embodiment, which is an embodiment disclosed here will be described in detail with reference to the drawings. First, a vehicle 2 equipped with a vehicle door control device 1 according to the first embodiment will be described below. FIG. 1 is a schematic configuration view showing the vehicle 2 according to the first embodiment. FIG. 2 is a block diagram showing the vehicle door control device 1 according to the first embodiment. In the following description, a front-rear direction of the vehicle 2, a left-right direction of the vehicle 2, and an up-down direction of the vehicle 2 are simply referred to as a front-rear direction, a left-right direction, and an up-down direction, respectively. In addition, a reference sign of a device or the like on the right side of the vehicle 2 may be denoted by R, and a reference sign of a device or the like on the left side of the vehicle 2 may be denoted by L. In addition to the components shown in FIGS. 1 and 2, the vehicle 2 also includes basic components of the vehicle 2. However, the following description will mainly focus on the configuration related to the control of the opening and closing of the doors, and the control related to the configuration.

As shown in FIG. 1, the vehicle 2 is, for example, a vehicle having a handle 3 on a right side, and includes a vehicle body 11, a front door 12R on a driver's seat side, a front door 12L on a passenger's seat side, a rear door 13R on the driver's seat side, a rear door 13L on the passenger's seat side, and a back door 14. Hereinafter, the front doors 12R and 12L, the rear doors 13R and 13L, and the back door 14 may be collectively referred to as doors. Each door is, for example, a swing type door. The vehicle 2 includes door lock devices 15A, 15B, 15C, 15D, and 15E that control locking of the respective doors, and door opening and closing devices 16A, 16B, 16C, 16D, and 16E that open and close the respective doors. The door lock devices 15A to 15E control locking of the front doors 12R and 12L, the rear doors 13R and 13L, and the back door 14 in this order. The door lock devices 15A to 15E are devices that switch the respective doors between a locked state in which the door is locked and an unlocked state in which the door is unlocked. The door opening and closing devices 16A to 16E are devices that open and close the front doors 12R and 12L, the rear doors 13R and 13L, and the back door 14 in this order. Each of the door opening and closing devices 16A to 16E includes, for example, a motor as a drive source, and opens and closes each door by driving the motor.

A configuration of the vehicle 2 shown in FIG. 1 is an example. For example, the vehicle 2 is not limited to a vehicle having the handle 3 on the right side, and may be a vehicle having the handle 3 on the left side. In addition, each door is not limited to a swing type door, and other opening and closing type doors such as a slide door can be adopted. The doors may be opened and closed in different manners. Therefore, only the rear doors 13R and 13L may be slide doors. The drive source of the door opening and closing devices 16A to 16E is not limited to the motor, and may be another drive source such as a hydraulic cylinder. The vehicle 2 may be an internal combustion engine automobile using an internal combustion engine (engine or the like) as a drive source, an electric vehicle using an electric motor as a drive source, a fuel cell vehicle, or a hybrid vehicle having a plurality of drive sources thereof. A vehicle type, the number of wheels, and the like of the vehicle 2 are not particularly limited. Further, the vehicle 2 may be a vehicle capable of manual driving, a vehicle capable of autonomous driving, or a vehicle capable of switching between manual driving and autonomous driving.

As shown in FIGS. 1 and 2, the vehicle door control device 1 includes a front camera 5, side cameras 6R and 6L, a rear camera 7, various sensors 8, a wireless communication device 9, a vehicle control electronic control unit (ECU) 10, and a position information acquisition device 17. Hereinafter, the front camera 5, the side cameras 6R and 6L, and the rear camera 7 may be collectively referred to as cameras.

Each camera is, for example, an imaging device having a solid-state imaging element such as a CCD, and captures an image of the surroundings of the vehicle. The front camera 5 is attached to, for example, an upper side of a front bumper of the vehicle 2 and a back side of a room mirror, and is installed in a state where an optical axis direction is directed to the front of the vehicle 2. The side cameras 6R and 6L are attached to, for example, left and right side mirrors of the vehicle 2, respectively, and are installed in a state where an optical axis direction is directed to a side of the vehicle 2. The rear camera 7 is attached above a license plate mounted on the rear side of the vehicle 2, for example, and is installed in a state where an optical axis direction is directed to the rear of the vehicle 2.

The various sensors 8 are sensors for realizing various functions of the vehicle 2. As the sensor 8, for example, an ultrasonic sensor, a millimeter wave radar, and a laser sensor may be used as a sensor for detecting an obstacle around the vehicle. Alternatively, the sensor 8 may be a vehicle speed sensor, an acceleration sensor, a gyro sensor, a steering sensor, a shift position sensor, or the like, as a sensor used for traveling of the vehicle 2.

The wireless communication device 9 is a device that performs wireless communication with a portable device 41. The portable device 41 is, for example, a so-called electronic key. Alternatively, the portable device 41 may be a smartphone used in a digital key system, or may be another communication terminal capable of wirelessly communicating with the vehicle 2. The portable device 41 includes buttons for operating the door lock devices 15A to 15E and the door opening and closing devices 16A to 16E.

The position information acquisition device 17 includes, for example, a receiver that receives radio waves from a global positioning system (GPS) satellite. The position information acquisition device 17 acquires position information of the vehicle 2 from the radio waves received at predetermined intervals. The vehicle control ECU 10 can detect a current position, a moving speed, and the like of the vehicle 2 based on position information of the position information acquisition device 17. The vehicle control ECU 10 may acquire the position information of the vehicle 2 from another device such as a car navigation system.

### Regarding Vehicle Control ECU 10

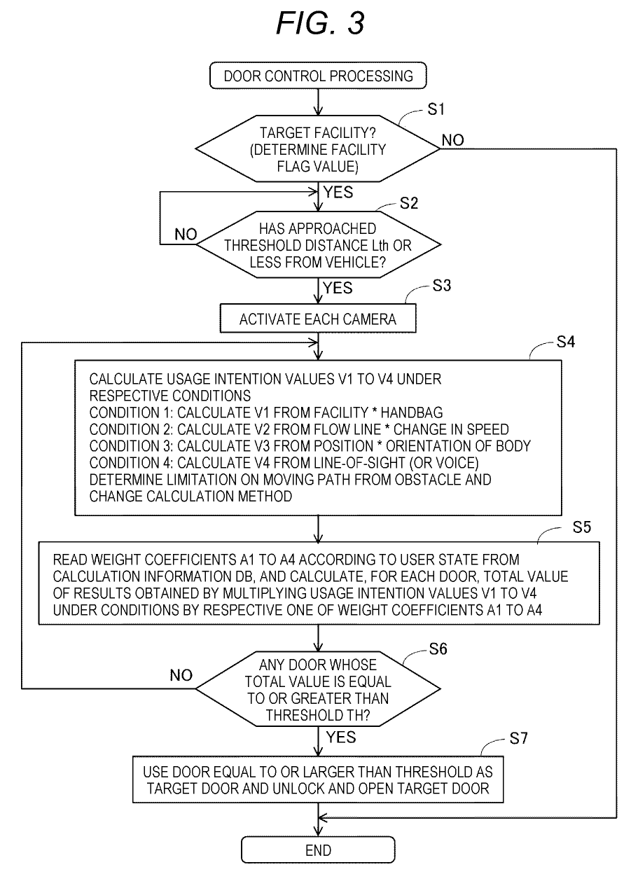

The vehicle control ECU (hereinafter, simply referred to as an ECU) 10 is an electronic control unit that comprehensively controls the entire vehicle 2 including the vehicle door control device 1. The vehicle control ECU 10 includes a CPU 31 serving as a calculation device and a control device, and internal storage devices such as a RAM 32 used as a working memory when the CPU 31 executes various kinds of calculation processing, a ROM 33 in which a door control processing program (see FIG. 3) to be described later and the like are stored in addition to a control program, and a flash memory 34 that stores a program and a flag value read from the ROM 33.

The ECU 10 realizes various functional units by executing programs by the CPU 31. For example, a usage intention value calculation unit 31A is a functional unit that calculates, for each of a plurality of conditions in which targets of calculation sources are different, a usage intention value indicating a possibility that a user present around the vehicle uses the vehicle. A target door estimation unit 31B is a functional unit that estimates a target door, which is a door expected to be opened by the user among the doors of the vehicle, based on the usage intention value calculated by the usage intention value calculation unit 31A. A control unit 31C is a functional unit that executes control for opening the door relative to the target door estimated by the target door estimation unit 31B. An obstacle detection unit 31D is a functional unit that detects an obstacle present around the vehicle. That is, the vehicle control ECU 10 is an example of a usage intention value calculation unit, a target door estimation unit, a control unit, and an obstacle detection unit in the present specification.

Further, calculation information DB 35 is stored in the flash memory 34. In the calculation information DB 35, information necessary for the usage intention value calculation unit 31A to calculate the usage intention value is stored, and a value or the like used for calculation for each of a plurality of conditions is stored. In addition, in the calculation information DB 35, a weight coefficient for multiplying the usage intention value for each of the plurality of conditions calculated by the usage intention value calculation unit 31A is stored for each of the plurality of conditions. In the calculation information DB 35, for example, a weight coefficient for each state of the user to be described later is stored. The flash memory 34 stores a facility flag value 36. The facility flag value 36 is a flag value for determining whether a facility in which the vehicle 2 is parked is a target facility for which the target door is estimated from the usage intention value.

The ECU 10 is connected to the door lock devices 15A to 15E, the door opening and closing devices 16A to 16E, the cameras (the front camera 5 and the like), the various sensors 8, the wireless communication device 9, and the position information acquisition device 17 via an in-vehicle network such as a CAN. The ECU 10 executes various calculations based on information input from each camera and each sensor 8, and controls the vehicle 2. For example, the ECU 10 displays a bird's-eye view image or an overhead image on a monitor (not shown) of the vehicle 2 based on imaging data captured by each camera, and executes driving assistance.

Further, the ECU 10 drives the door lock devices 15A to 15E and the door opening and closing devices 16A to 16E to control locking (key) of each door and opening and closing of the door. The ECU 10 executes wireless communication with the portable device 41 via the wireless communication device 9, and executes key authentication, unlocking of each door, opening and closing of the door, and the like according to a button operated on the portable device 41. Processing such as key authentication and locking of a door may be executed by a device other than the ECU 10, for example, the wireless communication device 9.

### Regarding Door Control Processing Program

Next, the door control processing program executed by the ECU 10 in the vehicle door control device 1 having the above-described configuration will be described with reference to FIG. 3. FIG. 3 is a flowchart of the door control processing program according to the first embodiment. Here, for example, when the ECU 10 detects radio waves from the portable device 41 in a state where an engine of the vehicle 2 is stopped and all the doors are locked, the ECU 10 starts the door control processing program. The door control processing program is a program that calculates, for each of the plurality of conditions in which targets of calculation sources are different, a usage intention value (hereinafter, referred to as a usage intention value V) indicating a possibility (probability) that the user uses the vehicle, estimates a door expected to be opened by the user (hereinafter, referred to as a target door) based on the calculated usage intention value V, and executes control for opening the door relative to the estimated target door. In the following description, a case where control for unlocking and opening the target door is executed as control for opening the door will be described.

The target of the calculation source will be described later in S4. The "control for opening the door" in the present specification may be control for unlocking each door or control for opening each door. Therefore, the ECU 10 may execute only the control for unlocking the target door in S7 of FIG. 3 to be described later. A condition for starting execution of a door control program is not limited to the above-described condition. The ECU 10 may execute the processing of FIG. 3 in a state where the engine of the vehicle 2 is started and the portable device 41 is inside the vehicle. For example, when the ECU 10 detects that a user who does not have the portable device 41 approaches a position at a predetermined distance from the vehicle 2 in a state where the engine of the vehicle 2 is started and all the doors of the vehicle 2 are locked, the ECU 10 may start the processing of FIG. 3 to the user as a target. Alternatively, the ECU 10 may execute the processing of FIG. 3 when it is detected that all the doors are unlocked by the portable device 41 in a state where the engine of the vehicle 2 is stopped and all the doors are locked. In this case, when the user intends to use the vehicle 2, the ECU 10 may execute control to open a target door that has already been unlocked. That is, as the "control for opening the door" in the present specification, only the control for opening the target door may be executed. In the present specification, the intention to use the vehicle is not limited to an intention to open each door and get in the vehicle, and includes an intention to open each door and work without getting in the vehicle, such as an intention to open each door and put a package, and an intention to take out a package. Therefore, the door in the present specification includes the back door 14. The program shown in the flowchart in FIG. 3 is stored in the RAM 32 or the ROM 33 of the vehicle door control device 1 and is executed by the CPU 31.

First, in step (hereinafter abbreviated as S) 1 of FIG. 3, the CPU 31 determines whether the facility in which the vehicle 2 is parked is a target facility (hereinafter referred to as a target facility) in which S2 and subsequent steps are executed, that is, whether the facility is a target facility in which calculation of the usage intention value V, estimation of the target door, and control of the estimated target door are executed. In S1, the CPU 31 determines whether the parked facility is the target facility based on the facility flag value 36 stored in the flash memory 34.

For example, the CPU 31 stores the facility flag value 36 based on the position information when the vehicle 2 is parked last time. When the engine of the vehicle 2 is stopped and an accessory power supply is turned off during parking, the CPU 31 acquires position information from the position information acquisition device 17 and detects the facility in which the vehicle 2 is parked based on the acquired position information and map information. The map information may be information acquired from a car navigation system attached to the vehicle 2, information stored in the ROM 33 or the like, or information acquired from an external server or the like.

For example, when the user parks the vehicle 2 at home, the user often walks around the vehicle 2 even when the user does not use the vehicle 2, and thus the user may want to manually (by an electronic key or the like) open a door without performing the door control processing in FIG. 3 at home. Alternatively, there is a possibility that the user may want to make a specific facility such as an office or a hospital as a non-target. Therefore, the CPU 31 receives information on the non-target facility to be excluded from the target of the door control processing. A method for receiving information on the non-target facility is not particularly limited, and may be a method using a car navigation system or a method using another user interface of the vehicle 2.

When the engine of the vehicle 2 is stopped or the like during parking, the CPU 31 determines whether the facility in which the vehicle 2 is parked is a non-target facility, that is, whether a parking facility is a target facility. For example, the CPU 31 stores a value of "1" in the facility flag value 36 when the parking facility is the target facility, and stores a value of "0" in the facility flag value 36 when the parking facility is the non-target facility. After starting the processing of FIG. 3, in S1, the CPU 31 determines the facility flag value 36 stored at the time of the previous parking, and determines whether the parking facility is the target facility.

When the facility flag value 36 is "1", the CPU 31 determines that the parking facility is the target facility (S1: YES), and executes S2. On the other hand, when the facility flag value 36 is "0", the CPU 31 determines that the parking facility is the non-target facility (S1: NO), and ends the processing shown in FIG. 3. Accordingly, the non-target facility can be registered according to the request of the user, and usability can be improved. In this case, it is not necessary to execute the processing in FIG. 3 until the vehicle 2 moves and the parking facility is changed, for example. Therefore, the CPU 31 may not execute the processing in FIG. 3 until the conditions such as the change of the current position, the update of the facility flag value 36, the change of the registered facility, and the start of the engine are satisfied.

In S2, the CPU 31 determines whether the user has approached a predetermined threshold distance Lth or less from the vehicle 2. While the user does not approach the threshold distance Lth, that is, while a distance between the vehicle 2 and the user holding the portable device 41 is longer than the threshold distance Lth, the CPU 31 makes negative determination in S2 (S2: NO), and repeatedly executes the determination processing of S2. When the CPU 31 detects that the user has approached the threshold distance Lth or less (S2: YES), the CPU 31 executes S3 and activates the cameras (the front camera 5, the side cameras 6R and 6L, and the rear camera 7). For example, the CPU 31 stops power supply to each camera and stops each camera until S3 is executed. In S3, the CPU 31 starts power supply to each camera and acquires imaging data from each camera in a state where imaging is possible.

The threshold distance Lth is, for example, several meters. As will be described later, after the user has approached the threshold distance Lth or less (S2: YES), the CPU 31 calculates the usage intention value V based on the imaging data of each activated camera, estimates the target door from the calculated usage intention value V, and executes control to open the target door. Therefore, the threshold distance Lth is preferably, for example, a distance, such as 5 m to 3 m, that can secure a time required for calculation or estimation and a time sufficient for the user approaching the vehicle 2 not to enter a swing range of the target door. Further, as a method for determining whether the user has approached the threshold distance Lth or less from the vehicle 2, for example, a method for determining from the position information of the portable device 41 can be adopted. For example, a position of the portable device 41 (user) may be detected using triangulation based on distances between a plurality of wireless antennas of the wireless communication device 9 and the portable device 41. The position of the portable device 41 may be detected from position information of a smartphone of the digital key system. Alternatively, a position of the user may be detected using a millimeter wave radar mounted on the vehicle 2. The CPU 31 may limit the camera to be activated according to the position of the user. For example, when the user is present in front of the vehicle 2, the rear camera 7 may not be activated. The camera activated according to the position of the user may be changed to save power.

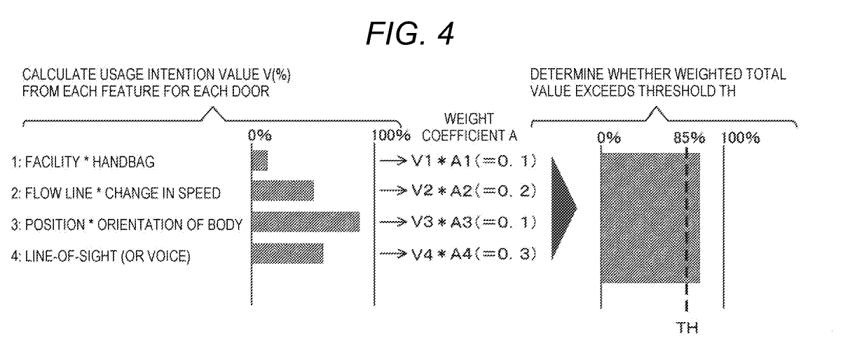

After executing S3, the CPU 31 executes S4 and calculates the usage intention value V for each of the plurality of conditions in which the targets of calculation sources are different. FIG. 4 shows a flow from calculation of the usage intention value V to determination based on a threshold TH. As shown in FIGS. 3 and 4, in the first embodiment, as an example, a case in which four conditions of conditions 1 to 4 are used will be described. In the following description, the usage intention values V of the conditions 1 to 4 are referred to as usage intention values V1 to V4 in this order, and the usage intention values V1 to V4 are collectively referred to as the usage intention value V. As shown in FIG. 4, the CPU 31 calculates the usage intention values V1 to V4 at a ratio of, for example, 0% to 100% for the conditions 1 to 4. The CPU 31 calculates, for each door, the usage intention values V1 to V4 for each of the plurality of conditions. In addition, the CPU 31 determines whether a moving path is limited from information on an obstacle around the vehicle, and when the moving path is limited, the CPU 31 changes (adjusts) a calculation method of the usage intention values V1 to V4 under each condition. First, a case where the moving path is not limited by an obstacle will be described. The number of the plurality of conditions in the present specification is not limited to four, and may be two, three, or five or more.

Condition 1: Combination of Facility and Handbag

First, the condition 1 will be described. In the calculation of the usage intention value V1 under the condition 1, the usage intention value V1 is calculated by a combination of two pieces of information, that is, information on a "facility" where the vehicle 2 is parked and information on a "handbag" held by the user as targets of the calculation source. The information on the facility may be acquired from position information of the position information acquisition device 17, map information of a car navigation system, or the like. The information on the handbag may be acquired from, for example, imaging data of the user captured by each camera. The information on the handbag may be acquired from information other than the cameras, for example, point cloud data of the millimeter wave radar.

For example, in a case of a combination where the facility is an airport and the handbag is a suitcase, there is a possibility that the user has returned from a trip to the vehicle 2 stopped at a parking lot of the airport, and a possibility that the user uses the vehicle 2 is high. Therefore, in the case of such a combination, the CPU 31 increases the usage intention value V1 calculated under the condition 1. On the other hand, for example, if the facility is at home and there is no handbag, there is a possibility that the user walks around the vehicle 2 stopped in a parking lot of home for a purpose other than getting in the vehicle, and the possibility of using the vehicle 2 is not necessarily high. Therefore, in the case of such a combination, the CPU 31 decreases the usage intention value V1 calculated under the condition 1.

If the handbag has a size like a carrier bag, there is a possibility that a user 43 may open the back door 14 and the rear doors 13R and 13L. If the handbag is a large package such as a suitcase, a possibility that the user 43 opens the back door 14 is high. Therefore, for example, the CPU 31 may increase the usage intention value V1 in the order of the front doors 12R and 12L, the rear doors 13R and 13L, and the back door 14 as the size of the handbag increases.

In the calculation information DB 35, for example, the usage intention value V1 for each combination of a facility, a type of handbag, and a type of door is set. The CPU 31 can set the usage intention value V1 of each door by searching the calculation information DB 35 for a combination that matches the detected information on facility and handbag. For example, a correction coefficient for correcting the usage intention value V1 from the size of the handbag, the number of handbags, or the like may be set in the calculation information DB 35. The CPU 31 may correct the usage intention value V1 of the condition 1 based on the correction coefficient. For example, the larger a size of the handbag, the higher the possibility that the user uses the vehicle 2. Therefore, the CPU 31 may execute correction to increase the usage intention value V1 of each door by multiplying the usage intention value V1 by a correction coefficient as the size of the handbag increases. The larger the number of handbags, the higher the possibility that the user uses the vehicle 2. Therefore, the CPU 31 may perform correction to increase the usage intention value V1 as the number of handbags increases. For other conditions 2 to 4, similarly to the condition 1, a correction coefficient or the like necessary for calculation may be set in the calculation information DB 35.

The combination of the condition 1 described above is an example, and a relation between the facility and the handbag can be changed as appropriate. For example, if the facility is at home and the handbag is a carrier bag, there is a possibility that the user goes to shopping by means other than the vehicle 2 such as a bicycle and returns to home, and the possibility of using the vehicle 2 is not necessarily high. Therefore, in the case of such a combination, the CPU 31 may decrease the usage intention value V1. On the other hand, when the facility is a shopping mall and the handbag is a carrier bag, there is a possibility that the user who has finished shopping has returned to the vehicle 2, and the possibility of using the vehicle 2 is high. Therefore, in the case of such a combination, the CPU 31 may increase the usage intention value V1. As described above, under the condition 1, the situation of the user can be assumed and verified according to various facilities and types of handbags, and the calculation method of the usage intention value V1 can be set.

### Condition 2: Combination of Flow Line and Change in Speed

Next, the condition 2 will be described. In the following description of the conditions 2 to 4, the description of the same content as the condition 1 described above will be omitted as appropriate. In the calculation of the usage intention value V2 under the condition 2, the usage intention value V2 is calculated by a combination of two pieces of information, that is, information on the "flow line" of the user heading for the vehicle 2 and information on the "change in speed" of the moving speed of the user as targets of the calculation source. The information on the flow line and the change in speed may be acquired from the imaging data of each camera.

For example, if the user moves in a straight line toward the vehicle 2 and the moving speed rapidly decreases near any door, the possibility of using the vehicle 2 is high. Therefore, in the case of such a combination, the CPU 31 increases the usage intention value V2 calculated under the condition 2. If the user is walking in a straight line toward any door, a possibility that the user opens a destination door is high. Therefore, the CPU 31 sets the usage intention value V2 of a door, which is the destination of the movement along the straight line, to be relatively larger than the usage intention values V2 of other doors.

On the other hand, for example, when the user moves forward of the vehicle 2 and decelerates, when the user moves parallel to the side surface of the vehicle 2 at a constant speed, or when the user moves in a direction away from the vehicle 2, the possibility of using the vehicle 2 is low. Therefore, in the case of such a combination, the CPU 31 decreases the usage intention value V2 under the condition 2. For example, the CPU 31 decreases the usage intention values V2 of all the doors. In the calculation information DB 35, for example, the usage intention value V2 is set for each combination of a position, a moving direction of the user, an increase or decrease amount of a speed, and a type of the door.

### Condition 3: Combination of Position and Orientation of Body

In the calculation of the usage intention value V3 under the condition 3, the usage intention value V3 is calculated by a combination of two pieces of information, that is, information on the "position" of the user and information on the "orientation of body" of the user as targets of the calculation source. The information on the position and the orientation of the body may be acquired from the imaging data of each camera. The orientation of the body may be detected from the moving direction or a movement trajectory of the user, or may be detected from the movement of the shoulder, hand, foot, or the like of the user.

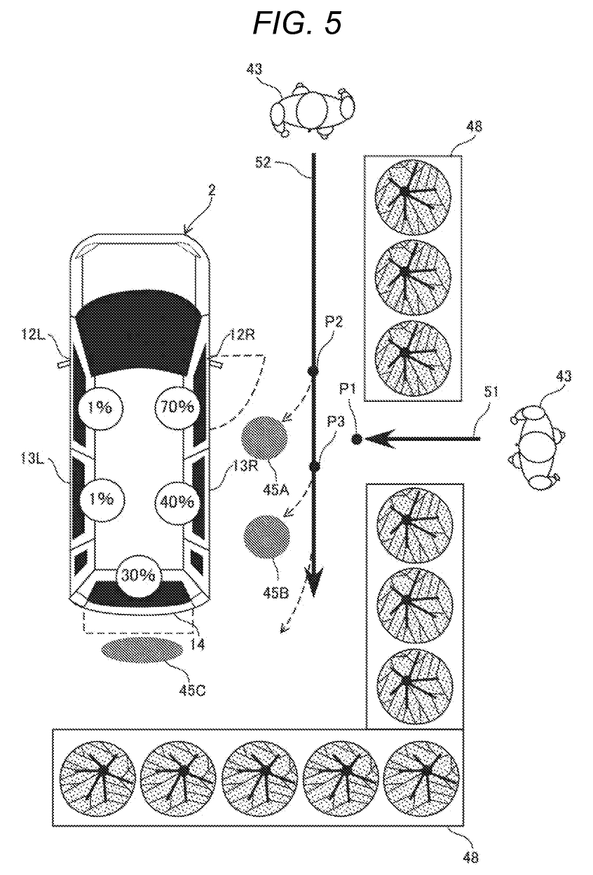

The CPU 31 calculates the usage intention value V3 by a combination of the position and the orientation of the body, such as a position where the user stops relative to the vehicle 2 and the orientation of the body faces the vehicle 2. Alternatively, the CPU 31 may calculate the usage intention value V3 from a combination of the position at which the user decelerates to such an extent that the user is likely to stop and the orientation of the body. FIG. 5 shows an example of a state in which the vehicle 2 is parked and a moving path of the user 43. For example, there is a possibility that the user 43 may stop in areas 45A to 45C shown in FIG. 5 when the user 43 gets in the vehicle or when the user 43 places a package. The area 45A is an area where the user 43 stops when opening the front door 12R, the area 45B is an area where the user 43 stops when opening the rear door 13R, and the area 45C is an area where the user 43 stops when opening the back door 14. Such an area can be set by verifying the position in advance according to the vehicle type or the like. The CPU 31 increases the usage intention value V3 when a position where the user 43 stops is within the areas 45A to 45C or the position close to the areas 45A to 45C.

When the position where the user 43 stops is the area 45A, the CPU 31 sets the usage intention value V3 of the front door 12R to be larger than the usage intention values V3 of other doors. For example, as indicated by percentage representation in FIG. 5, in the calculation information DB 35, a setting value is set such that when the user 43 stops in the area 45A, the usage intention value V3 of the front door 12R is set to 70% and the usage intention value V3 of the rear door 13R close to the front door 12R is set to 40%. In the calculation information DB 35, when the user 43 stops in the area 45A, the usage intention value V3 of the back door 14 is set to 30%. That is, with reference to the front door 12R corresponding to the area 45A where the user 43 stops, the usage intention value V3 of the back door 14 present at a position farther from the front door 12R than the rear door 13R is set to a value lower than the usage intention value V3 of the rear door 13R. In addition, in the calculation information DB 35, when the user 43 stops in the area 45A, the usage intention value V3 of the front door 12L or the rear door 13L that is present on a side opposite to the front door 12R (an opposite side of the vehicle 2) in the left-right direction is set to 1%. Accordingly, the CPU 31 can set the usage intention value V3 corresponding to the stop position for each door by calculating the usage intention value V3 with reference to the calculation information DB 35. Similarly, for example, when the position where the user 43 stops is in the area 45B, the CPU 31 refers to the calculation information DB 35 to maximize the usage intention value V3 of the rear door 13R and relatively decrease the usage intention value V3 of the other door according to a distance from the rear door 13R.

In addition, even when the user 43 stops in the area 45A or the like, the possibility of opening each door decreases depending on the orientation of the body, for example, when the body faces a side opposite to the door. For example, broken lines in FIG. 5 indicate movable areas when the front door 12R and the back door 14 are opened and closed. For example, when the user 43 gets in the vehicle 2 from the front door 12R, it is expected that the front door 12R opens in the movable area indicated by broken lines, and thus a possibility that the user 43 stops in the area 45A and turns his or her body to the left front (vehicle interior side) is high. Therefore, when such a combination of the position and the orientation of the body is detected, the CPU 31 increases the usage intention value V3 of the front door 12R. On the other hand, in a case where the user 43 stops in the area 45A, when the user 43 is standing with his or her body turned toward the rear of the vehicle 2, or when the user 43 stands making the body face in a right direction of the vehicle 2, the possibility that the user 43 gets in the vehicle 2 is low. Therefore, in the calculation information DB 35, a value of the usage intention value V3 is adjusted according to an orientation of a body of the user 43. For example, in a case where the user 43 stops in the area 45A and the orientation of the body faces toward the rear, the CPU 31 may decrease the usage intention value V3 of the front door 12R and increase the usage intention value V3 of the rear door 13R.

Similarly, in a case where the user 43 stops in the area 45C, even when the user 43 faces toward the rear, the possibility of performing work such as opening the back door 14 and placing a package is reduced. In this case, the CPU 31 decreases the usage intention value V3 of the back door 14. In a case where the rear door 13R is a slide door, the orientation of the body is an orientation facing the rear door 13R (an orientation in which the rear door 13R and a surface of the body are parallel to each other). Therefore, for example, in a case where the rear door 13R is a slide door, the user 43 stops in the area 45B, and the orientation of the body faces the front of the vehicle 2, the CPU 31 may decrease the usage intention value V3 of the rear door 13R and increase the usage intention value V3 of the front door 12R. As described above, the CPU 31 changes the usage intention value V3 according to the orientation of the body even when the position where the user 43 stops is within the areas 45A to 45C or near the areas 45A to 45C.

For example, the usage intention value V3 for each combination of the position where the user 43 stops, the orientation of the body, and a type of the door is set in the calculation information DB 35. The CPU 31 can set the usage intention value V3 for each door by searching the calculation information DB 35 for a combination that matches the detected information on the position and the orientation of the body. A correction coefficient for correcting the usage intention value V3 may be set in the calculation information DB 35 from a deviation amount between each of the areas 45A to 45C and a position where the user 43 actually stops. In addition, a correction coefficient for correcting the usage intention value V3 may be set in the calculation information DB 35 from a deviation amount between the set orientation (angle) of the body and the actual orientation of the body of the user 43. The CPU 31 may correct the usage intention value V3 based on the deviation amount of the position or the orientation and the correction coefficient.

### Condition 4: Line-of-sight or Voice

In the calculation of the usage intention value V4 under the condition 4, the usage intention value V4 is calculated based on at least one piece of information of the "line-of-sight" of the user 43 and the "voice" of the user 43 as targets of the calculation source. The information on the line-of-sight may be acquired from the imaging data of each camera, for example. In addition, the information on the voice may be acquired using a microphone of each camera or a voice collection device different from the camera.

For example, when there is an intention to use the vehicle 2, which part of the vehicle 2 should be viewed is registered in advance. In other words, when the user 43 wants to indicate the intention of use, the user 43 can indicate the intention of use by viewing a portion registered in advance. As a portion to be viewed, for example, a position of a door knob of each door and a position of a window of each door can be adopted. The CPU 31 increases the usage intention value V4 as a destination of the line-of-sight of the user 43 is closer to the pre-registered portion, and decreases the usage intention value V4 as the destination of the line-of-sight is farther from the registered portion. The calculation information DB 35 stores, for example, an arithmetic expression for calculating the usage intention value V4 from a difference between coordinates of the portion of the vehicle 2 to be viewed and coordinates of the destination of the line-of-sight of the user 43. When the CPU 31 detects that the destination of the line-of-sight of the user 43 is a portion (a door knob or a window) to be viewed of any door, the CPU 31 sets the usage intention value V4 of a door (a door viewed by the user 43) of the portion to be viewed to be relatively larger than the usage intention value V4 of other doors (doors not viewed).

The calculation method of the usage intention value V4 using the line-of-sight described above is an example. For example, the usage intention value V4 may be increased or decreased according to whether the destination of the line-of-sight of the user 43 is close to the vehicle 2. For example, when the face of the user 43 faces a vehicle 2 side, the possibility that the user 43 uses the vehicle 2 is high, and when the face of the user 43 faces a direction different from that of the vehicle 2, the possibility that the user 43 uses the vehicle 2 is low. Therefore, when the line-of-sight of the user 43 is directed to the vehicle 2, the usage intention value V4 may be increased as a distance of the door from the user 43 decreases. When the line-of-sight of the user 43 is directed in a direction different from that of the vehicle 2, there is a possibility that the user 43 passes by the vehicle 2 or come to pick up an object near the vehicle 2, for example. Therefore, for example, the CPU 31 may decrease the usage intention values V4 of all the doors as the destination of the line-of-sight of the user 43 moves away from the vehicle 2.

Regarding the voice, for example, what voice (keyword or the like) should be uttered when there is an intention to use the vehicle 2 is registered in advance. In other words, in a case where the user 43 wants to indicate the intention of use, what kind of words should be uttered is determined in advance. For example, a keyword specifying a door to be opened, such as "please open the door of the driver's seat", is registered. The CPU 31 analyzes voice data collected from the microphone of each camera, increases the usage intention value V4 as a degree of coincidence with a predetermined keyword is higher, and decreases the usage intention value V4 as the degree of coincidence is lower. Further, in the above-described example, since the front door 12R is designated by voice, the CPU 31 increases the usage intention value V4 of the designated front door 12R and relatively decreases the usage intention value V4 of the other door as the degree of coincidence with the keyword is higher. In the calculation information DB 35, keywords used for voice collation are stored.

The content of each condition and the calculation method described above are examples. For example, under the condition 1, the usage intention value V1 may be changed according to a shape of the handbag. In addition, under the condition 2, the degree of coincidence between a straight line connecting the vehicle 2 and a current position of the user 43 and the moving path of the user 43 may be determined, and the usage intention value V2 may be increased as the degree of coincidence is higher. In addition, under the condition 3, an angle of the shoulder of the user 43 when the user 43 who intends to use the vehicle stands in each of the areas 45A to 45C may be registered in advance. The usage intention value V3 may be increased as the degree of coincidence between the registered angle of the shoulder and the actually detected angle of the shoulder increases. Under the condition 4, the usage intention value V4 may be calculated based on only one of the line-of-sight and the voice. In addition, under the condition 4, a keyword that does not specify a door to be opened, such as "please open door", may be registered in advance. In this case, when the keyword is detected from the voice data collected by the microphone, the CPU 31 may increase the usage intention value V4 as a distance of a door from the current position of the user 43 is shorter.

In addition to or instead of the above-described conditions 1 to 4, for example, a combination of a "stroller" and "vehicle interior situation" may be added as a condition. When the user 43 pushes the stroller on which a baby is placed and approaches the vehicle 2, the user 43 first places the baby on a child seat before the user 43 gets in the vehicle 2. Therefore, when the CPU 31 detects the user 43 who pushes the stroller and approaches the vehicle 2, the CPU 31 may detect, by an in-vehicle camera, a position of a seat to which the child seat is attached and increase the usage intention value V of a door closest to the seat. Accordingly, before the user 43 arrives in front of the door of the seat to which the child seat is attached, the door can be opened first. The CPU 31 may calculate the usage intention values V1 to V4 for each door, or may not calculate the usage intention values V1 to V4. In this case, adjustment of the usage intention values V1 to V4 for each door may also be executed by weight coefficients A1 to A4 to be described later.

### Regarding Limitation on Moving Path by Obstacle

In S4, the CPU 31 detects an obstacle present around the vehicle 2. When the detected obstacle is an obstacle to the movement of the user 43, the CPU 31 changes a method for calculating the usage intention values V1 to V4 for each of the plurality of conditions based on the moving path of the user 43 limited by the obstacle, and calculates the usage intention values V1 to V4.

By calculating the usage intention values V1 to V4 for each of the plurality of conditions described above for each door and summing the calculated usage intention values V1 to V4 for each door, it is possible to determine which door the user 43 wants to open, that is, to detect the target door. However, a path along which the user 43 moves and a width of a path through which the user 43 passes are changed or limited by an obstacle around the vehicle. When the moving path or the like is changed, a flow line, a moving speed, a position, the movement of the body, the line-of-sight, a calculation timing, and the like of the user 43 are different from those in a case where there is no obstacle.

FIG. 5 shows a moving path of the user 43 when an obstacle 48 is present around the vehicle. The obstacle 48 is, for example, a tree planted in a parking lot. The obstacle 48 may be various objects such as a wall of a parking lot, materials placed in the parking lot, other vehicles, bicycles, guardrails, and other structures. The obstacle 48 may be a moving object such as a pedestrian. For example, the CPU 31 may acquire information on the obstacle 48 around the vehicle based on the imaging data of each camera, or may acquire the information on the obstacle 48 using another sensor such as a millimeter wave radar.

For example, as shown in the moving path 51 in FIG. 5, when the width of the moving path through which the user 43 passes is narrow enough for only one person to pass, the user 43 needs to walk along a direction indicated by the arrow of the moving path 51 when walking toward the vehicle 2. The moving path 51 is a moving path toward the front door 12R in a straight line. However, this flow line is a flow line of a result of passing through the moving path 51 limited by the obstacle 48. In other words, for example, even if the user 43 wants to go straight to the rear door 13R, the user 43 needs to pass through the moving path 51 due to the obstacle 48. Therefore, in a case where the user 43 who passes through such a moving path 51 is detected, when the usage intention value V2 of the front door 12R is increased based on the fact that the user 43 moves toward the front door 12R in a straight line in the calculation of the usage intention value V2 under the condition 2, there is a possibility that the usage intention value V of a door different from a door that the user 43 wants to open is increased. That is, the usage intention value V may be erroneously calculated.

Therefore, when the CPU 31 detects the positions of the obstacle 48 and the user 43 and detects that the user 43 passes through the moving path 51 limited by the obstacle 48 as shown in FIG. 5, or when the user 43 is expected to pass through the moving path 51, the CPU 31 executes, for example, adjustment to decrease the usage intention value V2. That is, as the accuracy of estimating the target door, the usage intention value V2 whose accuracy is reduced due to the obstacle 48 may be intentionally decreased. Alternatively, the CPU 31 may set the usage intention value V2 of all the doors to zero until the user 43 reaches a position P1 passing through the moving path 51 between the obstacles 48, and may calculate the usage intention value V2 based on a flow line or a change in speed after the user 43 reaches the position P1. In this way, the calculation method of the usage intention value V2 may be changed according to the moving path 51 limited by the obstacle 48.

For example, as shown in the moving path 52, when the moving paths toward the front door 12R, the rear door 13R, and the back door 14 are limited, it is difficult to determine toward which door among the three doors the user 43 is walking from the flow line. On the other hand, when the user 43 passes through the moving path 52, a possibility that the user 43 opens the left front door 12L or rear door 13L is low. Therefore, when the CPU 31 detects the obstacle 48 and the user 43 passes through the moving path 52 limited by the obstacle 48, for example, until the user 43 reaches a position P2 close to the area 45A of the front door 12R, the CPU 31 sets the usage intention values V2 of the front door 12R, the rear door 13R, and the back door 14 to the same value, and sets the usage intention values V2 of the left front door 12L and the left rear door 13L to zero. In addition, when the user 43 reaches a position P3 close to the area 45B of the rear door 13R after the user 43 passes the position P2 on the moving path 52, the CPU 31 may set the usage intention values V2 of the rear door 13R and the back door 14 to the same value, and may set the usage intention value V2 of the front door 12R that the user 43 has passed (a possibility of opening the door is low) to zero in addition to the front door 12L and the rear door 13L.

The calculation method of the usage intention value V other than the usage intention value V2 may be changed according to the moving path limited by the obstacle 48. For example, the usage intention values V1 to V4 of the front door 12R, the rear door 13R, and the back door 14 may be the same value until the user 43 reaches the position P1 on the moving path 51. When the user 43 reaches the position P1, the calculation of the usage intention values V1 to V4 of the front door 12R, the rear door 13R, and the back door 14 may be started. Further, for example, when the orientation of the body of the user 43 is limited by the obstacle 48, and for example, there is a moving path along which a person can walk only in a lateral direction, the usage intention values V2 to V4 may be set to constant values until the user 43 gets out of the moving path.

### Regarding Weight Coefficients A1 to A4

The CPU 31 executes S5 after executing S4, and calculates, for each door of the vehicle 2, a total value of values obtained by multiplying the usage intention values V1 to V4 under the plurality of conditions calculated in S4 by a respective one of the weight coefficients under the plurality of conditions. For example, the weight coefficients by which the usage intention values V1 to V4 are multiplied are set as the weight coefficients A1 to A4. In this case, the CPU 31 calculates, as a total value, a value obtained by V1 * A1 + V2 * A2 + V3 * A3 + V4 * A4, and calculates the total value for each door. The CPU 31 changes the weight coefficients A1 to A4 based on a state of the user 43. The weight coefficients A1 to A4 are collectively referred to as a weight coefficient A. The weight coefficients A1 to A4 according to different states of the user 43 described below are stored in the calculation information DB 35.

By adjusting the weight coefficients A1 to A4, the CPU 31 increases the weighting of the usage intention value V in which the intention of the user 43 is easily reflected, that is, the accuracy of estimating the target door is high, in determining a target door. For example, when the user 43 holds a handbag, the usage intention value V1 having the handbag as a condition has higher accuracy than the other usage intention values V in the accuracy of estimating the target door. For example, different weight coefficients A1 to A4 are set in the calculation information DB 35 depending on whether the user 43 holds a handbag. In the calculation information DB 35, a value for setting the weight coefficient A1 of the usage intention value V1 to be larger than the weight coefficients A2 to A4 of the other usage intention values V2 to V4 is set on a condition that the user 43 holds a handbag. Accordingly, when the CPU 31 detects that the user 43 holds a handbag based on the imaging data of each camera, the CPU 31 can set the weight coefficient A1 of the usage intention value V1 to be larger than other weight coefficients A2 to A4 based on the calculation information DB 35.

For example, when the user 43 is operating a smartphone, even if the user 43 suddenly stops in front of any door, there is a possibility that the user 43 stops to view the smartphone. In this case, the usage intention value V3 under the condition 3 based on the stop position or the like may be lower in accuracy than the other usage intention values V1, V2, and V4 in the accuracy of estimating the target door. In the calculation information DB 35, different weight coefficients A1 to A4 are set depending on whether the user 43 holds or operates a smartphone. When the CPU 31 detects that the user 43 carries or operates a smartphone based on the imaging data of each camera, the CPU 31 sets the weight coefficient A3 of the usage intention value V3 to be smaller than other weight coefficients A1, A2, and A4 based on the calculation information DB 35.

Further, for example, the position and the orientation of the body of the user 43 when the user 43 stands near the vehicle 2 are different between a state where the stroller is pushed and a state where the stroller is not pushed. For example, there is a possibility that the user 43 faces the front with respect to the slide door when the stroller is not pushed, and stands in the orientation of the body at 90 degrees with respect to the slide door when the stroller is pushed. For example, there is a possibility that the user 43 may stand at a position away from the vehicle 2 by a size of a stroller or handbag. Therefore, when the CPU 31 detects that the user 43 holds a stroller, a suitcase, a shopping cart, a handbag, or the like based on the imaging data of each camera, the CPU 31 may set the weight coefficient A3 of the usage intention value V3, which is based on the position and the orientation of the body of the user 43, to be smaller than other weight coefficients A1, A2, and A4. The weight coefficients A1 to A4 may be different values for each door. Further, fixed values may be used as the weight coefficients A1 to A4. That is, the weight coefficients A1 to A4 may not be changed based on the state of the user 43.

### Comparison of Total Value with Threshold TH

In S5, the CPU 31 calculates, for each door, a total value obtained by multiplying the usage intention values V1 to V4 by the respective one of the weight coefficients A1 to A4. Then, in S6, the CPU 31 compares the total value of each door with the threshold TH. The CPU 31 determines a door whose total value is equal to or greater than the threshold TH as the target door, that is, a door that the user 43 wants to open. As shown in FIG. 4, the total value is calculated as 0 to 100%, for example. In the example shown in FIGS. 4, 85% is set as the threshold TH. The threshold TH may be a different value depending on the door.

When the total value of each of all the doors is less than the threshold TH in S6 (S6: NO), the CPU 31 executes the processing from S4 again, and executes calculation of the usage intention values V1 to V4 and the like. When the total value of at least one door is equal to or greater than the threshold TH, the CPU 31 makes an affirmative determination in S6 (S6: YES) and executes S7. When there is one door whose total value is equal to or greater than the threshold TH, the CPU 31 determines the door as the target door. When there are a plurality of doors whose total value is equal to or greater than the threshold TH, the CPU 31 may determine a door whose total value is the largest as the target door. Alternatively, the CPU 31 may determine all of the plurality of doors whose total value is equal to or greater than the threshold TH as the target doors. In this case, the plurality of doors may be opened together.

In S7, the CPU 31 unlocks a door determined in S6 that the total value is equal to or greater than the threshold TH, that is, the target door estimated based on the usage intention value V, and executes control to open the door. For example, when the target door is the front door 12R, the CPU 31 controls the door lock device 15A to unlock the front door 12R, and then controls the door opening and closing device 16A to execute control to open the front door 12R. Accordingly, the target door can be estimated based on the usage intention values V1 to V4 calculated for each of the plurality of conditions in which the targets of the calculation sources are different, and the target door estimated to be opened by the user 43 can be automatically opened.

### Effects of First Embodiment

As described above in detail, the first embodiment has the following effects. (1) According to the vehicle door control device 1 and a computer program executed by the vehicle door control device 1 according to the first embodiment, the CPU 31 of the ECU 10 calculates, for each of the plurality of conditions 1 to 4 in which targets of calculation sources are different, the usage intention values V1 to V4 indicating the possibility that the user 43 present around the vehicle 2 uses the vehicle 2 (S4). The CPU 31 estimates a target door expected to be opened by the user 43 among the doors of the vehicle 2 based on the calculated usage intention values V1 to V4 (S6). The CPU 31 executes control to unlock and open the estimated target door (S7).

Accordingly, the target door that the user 43 wants to open can be determined based on the plurality of different conditions, and the target door can be controlled. In the processing of determining the door that the user 43 wants to open, the target door can be estimated from various viewpoints while suppressing limiting to a specific condition, and thus the estimation accuracy of the target door can be improved, and the usability can be improved.

(2) In addition, the CPU 31 calculates, for each of the plurality of conditions, a total value (an example of an expected value in the present specification) based on the calculated usage intention values V1 to V4 for each door of the vehicle 2, and estimates a door whose total value is equal to or greater than the threshold TH as a target door.

Accordingly, by comparing the total value, which is the expected value based on the usage intention values V1 to V4 for each of the plurality of conditions, with the threshold TH, the target door can be estimated by comprehensively determining the plurality of conditions.

(3) The total value is calculated from values obtained by multiplying the usage intention values V1 to V4 for each of the plurality of conditions by the weight coefficients A1 to A4 for each of the plurality of conditions.

Accordingly, by comparing, with the threshold TH, the total value of the values obtained by multiplying the usage intention values V1 to V4 for each of the plurality of conditions by the weight coefficients A1 to A4 for each of the plurality of conditions, the target door can be estimated by comprehensively determining the plurality of conditions.

(4) The CPU 31 changes the weight coefficients A1 to A4 based on the state of the user 43. Accordingly, by calculating the total value for each door of the vehicle 2 and changing the weight coefficients A1 to A4 based on the state of the user 43, the total value can be calculated by the weight coefficients A1 to A4 according to the state of the user 43. The accuracy of estimating the target door can be improved.

(5) In addition, the CPU 31 changes the weight coefficients A1 to A4 according to whether the user 43 holds a handbag or according to the handbag of the user 43. Accordingly, it is possible to change the weight coefficients A1 to A4 according to whether the user 43 holds a handbag or what type of handbag is held. The handbag is various objects that can be carried by the user 43, such as a product purchased by shopping and a smartphone or a stroller of the user 43. By changing the weight coefficients A1 to A4 according to such a state of handbag, the accuracy of estimating the target door can be improved.

(6) The plurality of conditions according to the first embodiment include the condition 1 based on a relation between a facility in which the vehicle 2 is parked and a handbag held by the user 43, the condition 2 based on a relation between the flow line of the user 43 and a change in the moving speed of the user 43, the condition 3 based on a relation between the position of the user 43 and the orientation of the body of the user 43, and the condition 4 based on a relation between the vehicle 2 and the line-of-sight of the user 43.

In the case of the condition 1, it is possible to estimate whether the user 43 has an intention to use the vehicle 2 and which door is to be opened when the user 43 has an intention to use the vehicle 2 based on the parking facility (a type of the parking facility or the like) and the handbag (the presence or absence, a size, and the like of the handbag). In the case of the condition 2, it is possible to estimate whether the user 43 has an intention to use the vehicle 2 or the like base on what flow line the user 43 moves along to the vehicle 2 and what speed the user 43 changes. In the case of the condition 3, it is possible to estimate whether the user 43 has an intention to use the vehicle 2 or the like based on the position and the orientation of the body of the user 43 with respect to the vehicle 2. In the case of the condition 4, it is possible to estimate whether the user 43 has an intention to use the vehicle 2 based on whether the user 43 is looking at the vehicle 2, which part of the vehicle 2 the user 43 is looking at, or the like. By comprehensively determining these conditions 1 to 4, it is possible to accurately estimate the intention of use of the user 43 and a door to be opened.

(7) Further, the CPU 31 detects the obstacle 48 in S4, and when the detected obstacle 48 becomes an obstacle to the movement of the user 43, the CPU 31 changes the method for calculating the usage intention value V for each of the plurality of conditions based on the moving paths 51, 52 of the user 43 limited by the obstacle 48, and calculates the usage intention value V.

When the obstacle 48 is present around the vehicle, the moving paths 51, 52 along which the user 43 moves toward the vehicle 2 are limited by the obstacle 48. The behavior of the user 43 differs between a case where the moving paths 51, 52 are not limited and a case where the moving paths 51, 52 are limited. Therefore, it is necessary to change the calculation method of the usage intention value V for each condition according to a difference in the behavior of the user 43. The CPU 31 can improve the accuracy of estimating the target door by changing the calculation method of the usage intention value V for each of the plurality of conditions according to the limitation on the moving paths 51, 52 by the obstacle 48. As a result, usability can be improved.

### Second Embodiment

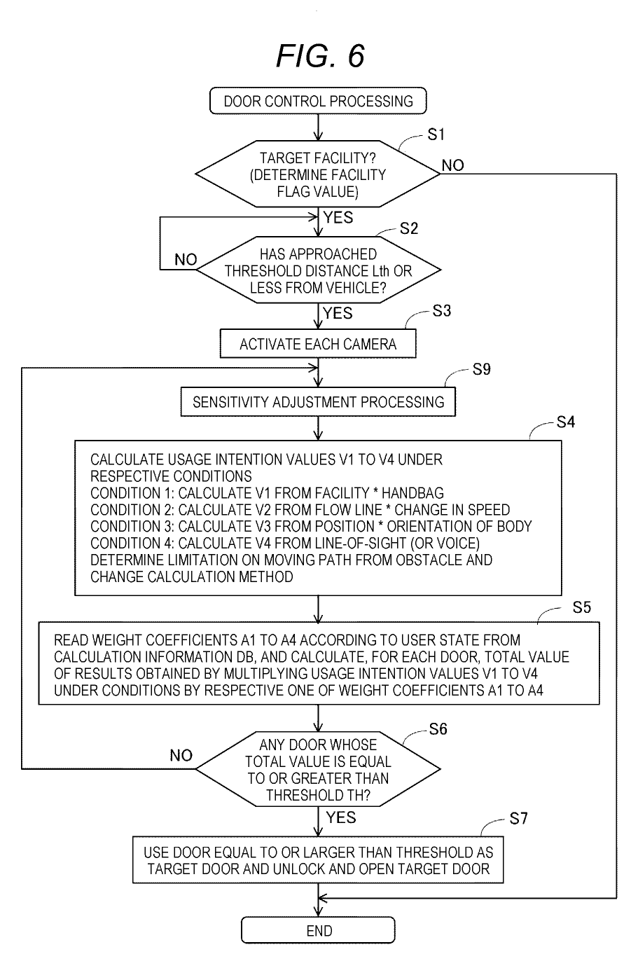

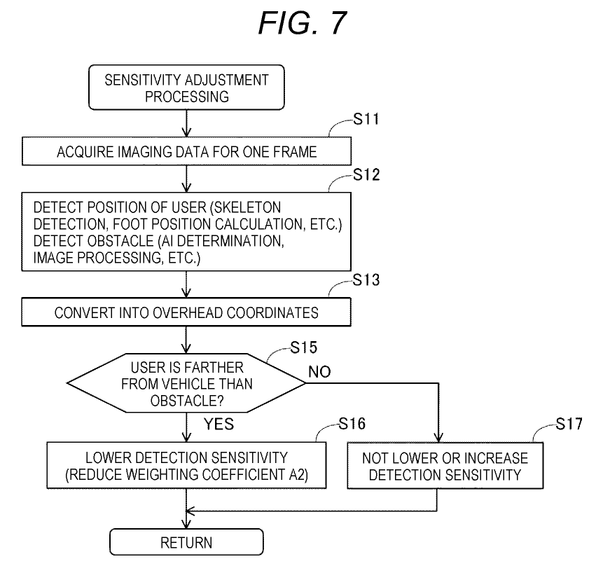

Next, a vehicle door control device according to a second embodiment, which is an embodiment disclosed here will be described in detail with reference to the drawings. FIGS. 6 and 7 show flowcharts of the door control processing program according to the second embodiment. In the first embodiment described above, in S4 of FIG. 3, when the CPU 31 detects that the user 43 passes through the moving path 51 limited by the obstacle 48 as shown in FIG. 5, or when the user 43 is expected to pass through the moving path 51, the CPU 31 executes, for example, adjustment to decrease the usage intention value V2. On the other hand, the CPU 31 according to the second embodiment is different from that according to the first embodiment in that execution of control for opening each door is limited until the user 43 approaches closer than the position of the obstacle 48. In the following description, the same contents as those of the first embodiment are denoted by the same reference numerals, and the description thereof will be appropriately omitted.

First, when starting the door control processing shown in FIG. 6, the CPU 31 executes the processing of S1 to S3 as in the first embodiment. When the parking facility is the non-target facility (S1: NO), the CPU 31 ends the processing shown in FIG. 6. On the other hand, the CPU 31 activates each camera (S3) when the parking facility is the target facility (S1: YES) and the user 43 has approached the threshold distance Lth or less (S2: YES). When the CPU 31 activates each camera and starts acquiring the imaging data, the CPU 31 executes sensitivity adjustment processing in S9.

As shown in FIG. 7, when the sensitivity adjustment processing is started, the CPU 31 acquires imaging data for one frame from each camera, for example (S11). As shown in FIG. 6, after executing the sensitivity adjustment processing in S9, the CPU 31 executes the processing in S4, S5, and S6 as in the first embodiment, and executes the processing in S9 again when the total value of all the doors is less than the threshold TH (S6: NO). Therefore, while the total value of all the doors is less than the threshold TH (S6: NO), the CPU 31 repeatedly executes the processing of acquiring the imaging data for one frame and executing S9 and S4 to S6 based on the acquired imaging data for one frame.

As shown in FIG. 7, after executing S11, the CPU 31 detects the position of the user 43 and the obstacle 48 around the vehicle based on the imaging data for one frame acquired in S11 (S12). For example, the CPU 31 detects a position of a skeleton of the user 43 present around the vehicle, specifically, positions of both shoulders, a position of the head, and the like, based on the imaging data. For example, the CPU 31 detects a position of a foot of the user 43 present around the vehicle based on the imaging data. The CPU 31 detects the position of the user 43 from the positions of the skeletons and the position of the foot. A method for detecting the position of the user 43 is not limited to a method for detecting a position of a skeleton or a foot from the imaging data described above, and may use a method for detecting the position from position information of the portable device 41, a method for detecting the position using a millimeter wave radar mounted on the vehicle 2, or the like as in the first embodiment.

The CPU 31 detects an obstacle using, for example, artificial intelligence (AI). For example, the ROM 33 stores an AI program. The AI program is, for example, an AI program of a learned model that has been subjected to machine learning (deep learning) using images of various imaging data captured from the vehicle 2 in a parked state as training data, and executes processing of estimating the position or the like of the obstacle 48 in an actual captured image. The CPU 31 executes the AI program and detects the obstacle 48 present around the vehicle from the imaging data. A range in which the obstacle 48 is detected is, for example, the same range as a range in which the user 43 is detected. A method for detecting the obstacle 48 is not limited to the method for determining by AI described above, and may be a method using the sensor 8 such as an ultrasonic sensor, a millimeter wave radar, or a laser sensor. Alternatively, the obstacle 48 may be detected by performing image processing on the image of the imaging data. As in the first embodiment, the obstacle 48 is a wall of a parking lot, a material placed in the parking lot, or the like.

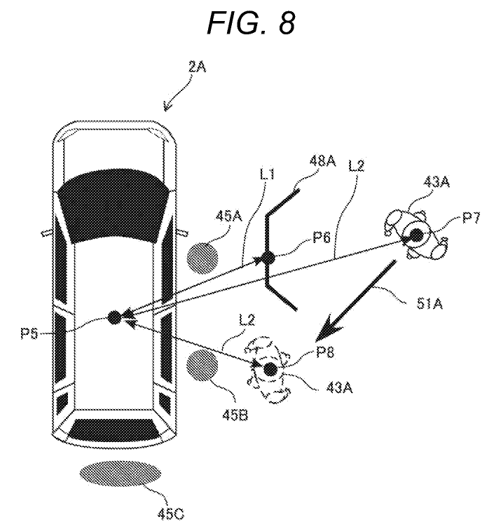

After executing S12, the CPU 31 converts positions of the user 43 and the obstacle 48 detected in S12 into overhead coordinates (S13). FIG. 8 shows an example of a positional relation between the vehicle 2, the obstacle 48, and the user 43. In order to distinguish the vehicle 2, the obstacle 48, and the user 43 in FIG. 8 from those in the first embodiment, the vehicle, the obstacle, and the user are hereinafter referred to as a vehicle 2A, an obstacle 48A, and a user 43A. As shown in FIG. 8, the CPU 31 acquires, for example, a distance L1 between a position P5 of the vehicle 2A and a position P6 of the obstacle 48A and a distance L2 between the position P5 of the vehicle 2A and a position P7 of the user 43A based on the position detected in S12. The definitions of the distances L1 and L2 are not limited to the definitions described above. For example, instead of using the distances L1 and L2 as the distances to the position P5, a distance between the position P6 or the position P7 and a position where the user 43A stops before opening each door, such as the area 45A, the area 45B, or the area 45C, may be adopted.

The position P5 is, for example, a position that is a center of the vehicle 2A in a plan view viewed from above. The position P6 is, for example, a position of the obstacle 48A closest to the position P5 of the vehicle 2A. The position P7 is, for example, a position that is a center of the user 43A in a plan view from above. The CPU 31 sets, for example, coordinates in a plan view, that is, an X-axis and a Y-axis of overhead coordinates (S13). The CPU 31 sets XY coordinates, sets the detected positions P6 and P7, and calculates a distance between the positions P5 and P6 as the distance L1. The CPU 31 calculates a distance between the positions P5 and P7 as the distance L2.

As shown in FIG. 7, after executing S13, the CPU 31 executes S15. The CPU 31 determines whether the user 43A detected in S12 is positioned farther from the vehicle 2A than the obstacle 48A detected in S12 (S15). The CPU 31 according to the second embodiment executes, for example, adjustment to change the weight coefficient A2 of the "condition 2: combination of flow line and change in speed" as a method for adjusting the sensitivity for detecting the target door. Accordingly, execution of control for opening the door relative to the target door is limited until the user 43A approaches a position closer to the vehicle 2A than the position P6 of the obstacle 48A.

The position P7 indicated by a solid line in FIG. 8 is, for example, a position where the user 43A is opposite to the vehicle 2A with the obstacle 48A interposed therebetween. When the user 43A is present at the position P7, the distance L2 is equal to or greater than the distance L1. In this case, the CPU 31 makes an affirmative determination in S15 (S15: YES), and executes S16. In S16, the CPU 31 executes control to lower the detection accuracy. For example, when the CPU 31 makes an affirmative determination in S15 (S15: YES), that is, when the user 43A is present at a position farther from the vehicle 2A than the obstacle 48A, the CPU 31 determines to reduce the weight coefficient A2 used in S5 of FIG. 6 (S16). As a result, a value obtained by multiplying the usage intention value V2 of the condition 2 calculated in S5, which will be described later, by the weight coefficient A2 decreases, and the total value calculated in S5 can be reduced. In S6, the total value is less likely to be equal to or greater than the threshold TH. In other words, an influence on the total value of the usage intention values V2 calculated from the condition 2, that is, a combination of flow line and change in speed can be reduced, and the total value can be reduced to make it difficult to execute S7. By lowering the detection sensitivity of the target door, the target door can be made difficult to open. For example, the CPU 31 may set the weight coefficient A2 to zero. Accordingly, as the accuracy of estimating the target door, it is possible to intentionally reduce the weight coefficient A2 of the usage intention value V2 whose accuracy may decrease due to the obstacle 48, and to prevent an erroneous door from opening.

On the other hand, a position P8 indicated by a broken line in FIG. 8 is, for example, a position where the user 43A is beside the obstacle 48A or a position where the user 43A has passed beside the obstacle 48A. When the user 43A is present at the position P8, the distance L2 is less than the distance L1. In this case, the CPU 31 makes a negative determination in S15 (S15: NO), and executes S17. In S17, the CPU 31 executes control not to lower or increase the detection accuracy. For example, when the CPU 31 makes a negative determination in S15 (S15: NO), that is, when the user 43A is present at a position closer to the vehicle 2A than the obstacle 48A, the CPU 31 determines to use the weight coefficient A2 read from the calculation information DB 35 without changing the weight coefficient A2 as the weight coefficient A2 used in S5 of FIG. 6 (S17). Accordingly, the value obtained by multiplying the usage intention value V2 of the condition 2 calculated in S5 by the weight coefficient A2 is not changed, and the sensitivity for detecting the target door can be maintained as usual. If the obstacle 48A around the vehicle is not detected in S12, the CPU 31 may make a negative determination in S15.

Alternatively, the CPU 31 may determine to increase the weight coefficient A2 in S17. Accordingly, the value obtained by multiplying the usage intention value V2 of the condition 2 calculated in S5 by the weight coefficient A2 can be increased, and the total value calculated in S5 can be increased. In S6, the total value is likely to be equal to or greater than the threshold TH. In other words, an influence on the total value of the usage intention values V2 calculated from the condition 2, that is, a combination of flow line and change in speed can be increased, and the total value can be increased to make it easy to execute S7. By increasing the detection sensitivity of the target door, the target door can be easily opened.

For example, when the obstacle 48A around the vehicle is detected in S12 and the user 43A is present at a position closer to the vehicle 2A than the obstacle 48A (S15: NO), the CPU 31 does not change the weight coefficient A2. On the other hand, when the obstacle 48A around the vehicle is not detected in S12, the CPU 31 makes a negative determination in S15 (S15: NO), and increases the weight coefficient A2. In this case, since the obstacle 48A is not present around the vehicle, the reliability of the usage intention value V2 based on the condition 2 increases. Therefore, an influence of the usage intention value V2 on the total value may be increased, and the target door may be easily opened based on the usage intention value V2.

After executing S16 or S17, the CPU 31 ends the sensitivity adjustment processing shown in FIG. 7. As shown in FIG. 6, after executing S9, the CPU 31 executes S4. The CPU 31 calculates the usage intention values V1 to V4 as in the first embodiment. In S4, the CPU 31 may not execute the "processing of changing the method for calculating the usage intention values V1 to V4 for each of the plurality of conditions based on the moving path of the user 43A limited by the obstacle 48A" executed in the first embodiment.

After executing S4, the CPU 31 calculates a total value using the weight coefficients A1 to A4 as in the first embodiment (S5). At this time, the CPU 31 adjusts the weight coefficient A2 with the control content determined in S16 or S17 of S9 described above. As in the first embodiment, the CPU 31 executes S6, and when the total value of all the doors is less than the threshold TH (S6: NO), the CPU 31 executes the processing from S9 again. The CPU 31 executes the processing in S9 and subsequent steps for the imaging data of the next one frame of each camera.

When the total value of at least one door is equal to or greater than the threshold TH (S6: YES), the CPU 31 executes control to unlock a door determined to have the total value equal to or greater than the threshold TH, that is, a target door estimated based on the usage intention value V and to open the door. Accordingly, the sensitivity related to the flow line can be adjusted based on the positional relation between the obstacle 48A and the user 43A, and an appropriate target door can be opened.

Here, as shown in FIG. 8, when the obstacle 48A is present around the vehicle, a moving path 51A of the user 43A is limited by the obstacle 48A. When the vehicle 2 does not recognize this situation, it may be determined that there is an intention to get in through a wrong target door, and the door may be opened. Specifically, in the state of the position P7 shown in FIG. 8, it is difficult to determine the intention of the user 43A as to whether the user 43A is going to approach the vehicle 2A or is going to move laterally only to avoid the obstacle 48A. In such a case, as described above, the sensitivity for determining the target door is adjusted based on the positional relation between the obstacle 48A and the user 43A.

While the user 43A is at a position far from the obstacle 48A, the CPU 31 can control each door not to be positively opened by decreasing the weight coefficient A2. When the user 43A is at a position close to the obstacle 48A, the CPU 31 returns the weight coefficient A2 to an original value to reflect the usage intention value V2, which is an estimation result of the target door based on the flow line of the condition 2, in the total value. Accordingly, for example, when the obstacle 48A is present between the vehicle 2A and the user 43A, the target door can be opened after the user 43A approaches the vehicle 2A while avoiding the obstacle 48A, or after it is detected that the user 43A stops in the area 45A or the like and the intention to get in the vehicle is reliably confirmed. The estimation of the target door, the confirmation of the intention to get in the vehicle, and the opening and closing of the target door can be accurately executed.

A method for limiting the execution of the control for opening the door and a method for adjusting the detection sensitivity of the target door are examples. For example, in the above description, the CPU 31 executes the limitation by changing a value of the weight coefficient A2, but this disclosure is not limited thereto. For example, when the CPU 31 makes an affirmative determination in S15 (S15: YES), the CPU 31 may determine to decrease the usage intention value V2 in S4 and implement the limitation.

Alternatively, when a weight coefficient is set for each of the flow line and the change in speed, only the weight coefficient of the flow line may be adjusted. When the obstacle 48A is present around the vehicle, the obstacle 48A may affect not only the orientation of the body under the condition 2 but also the orientation of the body under the condition 3, or the like. Therefore, the CPU 31 may change a weight coefficient of another condition, not limited to the condition 2, according to the presence or the position of the obstacle 48A.

When the obstacle 48A is present between the user 43A and the vehicle 2A, the CPU 31 may execute control to open the target door on a condition that the user 43A stands in front of the door of the vehicle 2A. That is, when the obstacle 48A is present, the control to open the target door may be executed at a timing at which the intention to get in the vehicle can be confirmed more reliably.

### Effects of Second Embodiment

As described above in detail, in the second embodiment, the same effects as those of the first embodiment are obtained. The second embodiment has the following effects.

(1) According to the vehicle door control device 1 and a computer program executed by the vehicle door control device 1 according to the second embodiment, the CPU 31 of the ECU 10 detects the obstacle 48A present around the vehicle 2A in S12, and limits the execution of the control for opening the door for the target door (S16) until the user 43A approaches a position closer to the vehicle 2A than the position of the detected obstacle 48A (S15: YES).

When the obstacle 48A is present at a position closer than the user 43A, the user 43A is likely to move in consideration of avoiding the obstacle 48A. Therefore, a flow line of the user 43A, that is, the moving path 51A is limited by the obstacle 48A. It is unclear whether the user 43A is moving toward the target door while avoiding the obstacle 48A, or whether the user 43A has to pass near the vehicle 2A due to the presence of the obstacle 48A, that is, whether the user 43A has no intention to get in the vehicle but is passing near the vehicle 2A. Therefore, the CPU 31 limits the control of opening the target door until the user 43A approaches the vehicle 2A more than the obstacle 48A by reducing the weight coefficient A2 related to the flow line. Accordingly, it is possible to prevent the target door from being erroneously opened when the user 43A simply passes near the vehicle 2A while avoiding the obstacle 48A. The estimation of the target door, the confirmation of the intention to get in the vehicle, and the opening and closing of the target door can be accurately executed.

(2) Further, the CPU 31 executes adjustment to reduce the total value (S16) until the user 43A approaches a position closer to the vehicle 2A than the position of the obstacle 48A (S15: YES).

Accordingly, by making the total value less likely to exceed the threshold TH, it is possible to prevent the target door from being erroneously opened when the user 43A is present at a position far from the vehicle 2A and the obstacle 48A is present.

(3) In addition, the CPU 31 multiplies the usage intention values V1 to V4 under the conditions 1 to 4 calculated in S4 by respective one of the weight coefficients A1 to A4 under the conditions 1 to 4 (S5), and calculates a sum of the multiplied values as a total value for each door. The CPU 31 executes adjustment to reduce the weight coefficient A2 of the condition 2, which is a flow line condition, until the user 43A approaches a position closer to the vehicle 2A than the position of the obstacle 48A (S15: YES) (S16).

Accordingly, by decreasing the weight coefficient A2, the total value can be made less likely to exceed the threshold TH. It is possible to prevent the target door from being erroneously opened.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

For example, the processing contents, the processing order, and the like of the flowcharts in the above embodiments are examples.

For example, the CPU 31 may not accept registration of a non-target facility. In this case, the CPU 31 may start the processing in FIGS. 3 and 6 from S2.

The CPU 31 may receive the registration of the target facility instead of the non-target facility and make the determination in S1, or may receive both the non-target facility and the target facility and make the determination in S1.

Further, for example, the CPU 31 may receive registration of a position where the user 43 gets in the vehicle, an orientation of the body when the user 43 gets in the vehicle, and the like, and execute the calculation in S4 based on the registered information. Accordingly, the calculation method of the usage intention value V can be customized according to physical features or requests of the user 43.

The plurality of conditions in the present specification may be at least two conditions among the conditions 1 to 4, and may include other conditions.

In each of the above embodiments, the processing is executed for the walking user 43 as a target, but this disclosure is not limited thereto. For example, even for the user 43 in a wheelchair, the target door may be estimated based on the conditions 1 to 4, and the estimated target door may be controlled. Therefore, a change in a moving speed of the user in the present specification is not limited to a change in a walking speed, and may be a change in a moving speed by a wheelchair.

When it is difficult to open each door, for example, when another vehicle is parked adjacent to the vehicle 2, the CPU 31 may stop the control of opening the target door or may execute adjustment such as reducing an amount of opening the target door.

When a plurality of target doors is estimated, the CPU 31 may execute control for opening the plurality of target doors simultaneously or in parallel. For example, the CPU 31 may execute control to open the front door 12R of the driver's seat while opening the sliding rear door 13R.

In each of the above embodiments, the ECU 10 of the vehicle door control device 1 executes the processing of the door control processing program (FIGS. 3 and 6), but an execution subject may be changed as appropriate. For example, the processing in FIGS. 3 and 6 may be executed by a control unit of a navigation device or other in-vehicle devices.

A configuration of the vehicle door control device 1 is not limited to the configuration of the above embodiments. For example, the vehicle door control device 1 may include only the ECU 10 or may include only the ECU 10 and each camera.

Next, technical ideas derived from the contents of the above embodiment will be described. (a) The vehicle door control device according to claim 1, in which

the control unit calculates the usage intention value and determines whether a parking facility in which the vehicle is parked is a target facility that is a target facility for which the target door is estimated, and

when the parking facility is not the target facility, the control unit does not execute the calculation of the usage intention value by the usage intention value calculation unit and the estimation of the target door by the target door estimation unit.

Accordingly, by registering the target facility in the vehicle door control device, the user can prevent the usage intention value from being calculated and the door from being automatically opened in the non-target facility. Usability can be improved by excluding the non-target facility according to the request of the user.

(b) The vehicle door control device according to claim 1, in which

the control unit determines whether the user has approached a threshold distance or less from the vehicle, and activates an imaging device attached to the vehicle when it is determined that the user has approached the threshold distance or less from the vehicle, and

the usage intention value calculation unit calculates the usage intention value based on imaging data of the activated imaging device.

Accordingly, power consumption can be reduced by stopping the imaging device until the user approaches a certain distance. When the user passes near the vehicle, it is possible to prevent unnecessary power consumption due to frequent activation of the imaging device or continuous activation of the imaging device. It is possible to prevent deterioration of a battery and death of the battery. Only when the user approaches the threshold distance or less and a possibility of using the vehicle increases, the imaging device is activated, and a usage intention value can be calculated based on the imaging data of the activated imaging device.

(c) The vehicle door control device according to claim 7, in which

the target door estimation unit executes adjustment to increase a weight coefficient of the flow line condition when the obstacle cannot be detected by the obstacle detection unit.

Accordingly, when there is no obstacle around the vehicle, the obstacle does not affect the flow line of the user. Therefore, by increasing the weight coefficient of the flow line condition, the detection accuracy of the target door can be improved based on the flow line of the user.

A vehicle door control device according to an aspect of this disclosure includes: a usage intention value calculation unit configured to calculate, for each of a plurality of conditions in which targets of calculation sources are different, a usage intention value indicating a possibility that a user present around a vehicle uses the vehicle; a target door estimation unit configured to estimate a target door, which is a door expected to be opened by the user among doors of the vehicle, based on the usage intention value calculated by the usage intention value calculation unit; and a control unit configured to execute control for opening the door on the target door estimated by the target door estimation unit.

The target of the calculation source in the present specification is a target that can be used to calculate the usage intention value, and is a target related to the vehicle such as a parking facility of the vehicle, a target related to the user such as a flow line of the user, or the like. In addition, the target of the calculation source is a target in which the usage intention value increases or decreases and the estimated target door is changed depending on a difference in a type or value of the target. In other words, the target of the calculation source is a target that can be used to estimate the target door expected to be opened by the user through the usage intention value. The calculation in the present specification is a concept including not only processing of calculating a value using an arithmetic expression or the like but also processing of determining and setting a suitable setting value from a plurality of setting values set in advance. The control for opening the door in the present specification is a concept including control for unlocking the door, control for opening the door, or control for executing both.

According to the vehicle door control device disclosed here having the above configuration, the usage intention value is calculated for each of the plurality of conditions in which the targets of the calculation sources are different, and the control for opening the door is executed on the target door estimated based on the calculated usage intention value. Accordingly, the target door that the user wants to open can be determined based on the plurality of different conditions, and the target door can be controlled. In the processing of determining the door that the user wants to open, the target door can be estimated from various viewpoints while suppressing limiting to a specific condition, and thus the estimation accuracy of the target door can be improved, and the usability can be improved.

What is claimed is:

1. A vehicle door control device comprising:
a usage intention value calculation unit configured to calculate, for each of a plurality of conditions in which targets of calculation sources are different, a usage intention value indicating a possibility that a user present around a vehicle uses the vehicle;
a target door estimation unit configured to estimate a target door, which is a door expected to be opened by the user among doors of the vehicle, based on the usage intention value calculated by the usage intention value calculation unit; and
a control unit configured to execute control for opening the door on the target door estimated by the target door estimation unit.

2. The vehicle door control device according to claim 1, wherein
the target door estimation unit calculates, for each door of the vehicle, an expected value based on the usage intention value for each of the plurality of conditions calculated by the usage intention value calculation unit, and estimates, as the target door, a door whose expected value is equal to or greater than a threshold.

3. The vehicle door control device according to claim 2, wherein
the expected value is calculated from a value obtained by multiplying the usage intention value for each of the plurality of conditions by a weight coefficient for each of the plurality of conditions.

4. The vehicle door control device according to claim 3, wherein
the target door estimation unit changes the weight coefficient based on a state of the user.

5. The vehicle door control device according to claim 3, wherein
the target door estimation unit changes the weight coefficient according to whether the user holds a handbag or according to the handbag of the user.

6. The vehicle door controls device according to claim 1, wherein the plurality of conditions includes at least two conditions among a condition based on relation between a facility in which the vehicle is parked and a handbag held the user, a condition bases on a relation between a flow line of the user and a change in a moving speed of the user, a condition based on a relation between a position of the user and an orientation of a body of the user, and a condition bases on a relation between the vehicle and a line-of-sight of the user.

7. The vehicle door control device according to claim 2, wherein the plurality of conditions includes at least two conditions among a condition based on a relation between a facility in which the vehicle is parked and a handbag held by the user, a condition based on a relation between a flow line of the user and a change in a moving speed of the user, a condition based on a relation between a position of the user and an orientation of a body of the user, and a condition based on a relation between the vehicle and a line-of-sight of the user.

8. The vehicle door control device according to claim 1, further comprising
an obstacle detection unit configured to detect an obstacle present around the vehicle, wherein
when the obstacle detected by the obstacle detection unit is an obstacle to movement of the user, the usage intention value calculation unit calculates the usage intention value by changing a method for calculating the usage intention value for each of the plurality of conditions, based on a moving path of the user limited by the obstacle.

9. The vehicle door control device according to claim 2, further comprising
an obstacle detection unit configured to detect an obstacle present around the vehicle, wherein
when the obstacle detected by the obstacle detection unit is an obstacle to movement of the user, the usage intention value calculation unit calculates the usage intention value by changing a method for calculating the usage intention value for each of the plurality of conditions, based on a moving path of the user limited by the obstacle.

10. The vehicle door control device according to claim 1, further comprising
an obstacle detection unit configured to detect an obstacle present around the vehicle, wherein
the control unit limits execution of control for opening the door relative to the target door estimated by the target door estimation unit until the user approaches a position closer to the vehicle than a position of the obstacle detected by the obstacle detection unit.

11. The vehicle door control device according to claim 2, further comprising
an obstacle detection unit configured to detect an obstacle present around the vehicle, wherein
the control unit limits execution of control for opening the door relative to the target door estimated by the target door estimation unit until the user approaches a position closer to the vehicle than a position of the obstacle detected by the obstacle detection unit.

12. The vehicle door control device according to claim 1, further comprising
an obstacle detection unit configured to detect an obstacle present around the vehicle, wherein
the target door estimation unit calculates, for each door of the vehicle, a total value of the usage intention values for the plurality of conditions calculated by the usage intention value calculation unit, estimates, as the target door, a door for which the total value is equal to or greater than a threshold, and executes adjustment to reduce the total value until the user approaches a position closer to the vehicle than a position of the obstacle detected by the obstacle detection unit.

13. The vehicle door control device according to claim 2, further comprising
an obstacle detection unit configured to detect an obstacle present around the vehicle, wherein
the target door estimation unit calculates, for each door of the vehicle, a total value of the usage intention values for the plurality of conditions calculated by the usage intention value calculation unit, estimates, as the target door, a door for which the total value is equal to or greater than a threshold, and executes adjustment to reduce the total value until the user approaches a position closer to the vehicle than a position of the obstacle detected by the obstacle detection unit.

14. The vehicle door control device according to claim 12, wherein
the plurality of conditions includes a flow line condition, which is a condition based on a flow line of the user, and
the target door estimation unit calculates, for each door of the vehicle, a sum of values obtained by multiplying the usage intention value for each of the plurality of conditions calculated by the usage intention value calculation unit by a weight coefficient for each of the plurality of conditions as the total value, and executes adjustment to reduce the weight coefficient of the flow line condition until the user approaches the position closer to the vehicle than the position of the obstacle detected by the obstacle detection unit.

15. The vehicle door control device according to claim 13, wherein
the plurality of conditions includes a flow line condition, which is a condition based on a flow line of the user, and
the target door estimation unit calculates, for each door of the vehicle, a sum of values obtained by multiplying the usage intention value for each of the plurality of conditions calculated by the usage intention value calculation unit by a weight coefficient for each of the plurality of conditions as the total value, and executes adjustment to reduce the weight coefficient of the flow line condition until the user approaches the position closer to the vehicle than the position of the obstacle detected by the obstacle detection unit.
